(19) United States
(12) Patent Application Publication
(10) Pub. No.: US 2004/0083903 A1
(43) Pub. Date: May 6, 2004

(54) Pallet for the steaming boxes in the inner pot of the roasting oven

(76) Inventor: Jian Wei-Wen, Guangdong (CN)

Correspondence Address: DICKINSON WRIGHT PLLC, Suite 800, 1901 L Street, N.W., Washington, DC, 20036, US

(21) Appl. No.: 10/370,497

(22) Filed: Feb. 24, 2003

(30) Foreign Application Priority Data
Oct. 30, 2002 (CN) 02248970.3

(51) Int. Cl. A47J 9/00

(52) U.S. Cl. 99/448; 99/483

(57) ABSTRACT

The present invention comprises a roasting oven comprising an inner pot, and a pallet with openings for holding steaming boxes. The pallet is of a foldable structure. The pallet of the utility model can be folded to be put in the inner pot. Therefore, the volume of the package is decreased and the cost of packaging and handling is lowered.

### TECHNICAL FIELD

The utility model is related to a pallet for steaming boxes in the inner pot of a roasting oven.

### BACKGROUND ART

In order to multiply functions there is a need to provide the inner pot of a roasting oven with steaming boxes for putting roasting food. When there is a need to steam food or to keep the food warm, water is usually poured into an inner pot and the steaming boxes containing food inside are put on the upper part of the inner pot, thereby heating the food. As shown in FIG. 1, in the existing electric roasting ovens or other roasting ovens a pallet (3) with openings (4) having its periphery laid on the upper rim of the inner pot (1) is provided for the steaming boxes (2) to be put on the upper part of the inner pot (1). The steaming boxes (2) are inserted into the openings (4) of the pallet (3) which is then put on the upper part of the inner pot (1). This structure increases the cost of the packaging during handling because of the diameter of the pallet (3) being greater than that of the inner wall of the inner pot (1) which prevents the pallet (3) from being put inside the inner pot (1).

### DISCLOSURE OF THE UTILITY MODEL

The objective of the utility model is to provide a pallet for the steaming boxes in the inner pot (1) of the roasting oven suitable for packaging and handling.

To solve the above stated problem, the present utility model has provided a pallet (3) with openings (4) wherein the pallet (3) is of a foldable structure, i.e, is foldable.

Because the pallet according to the utility model of the present invention is of a foldable structure which can be folded and put in the inner pot (1), the volume of the package is decreased and the cost of packaging and handling is lowered.

### BRIEF DESCRIPTION OF THE DRAWINGS

The present invention will become more fully understood from the detailed description given here below, the appended claims, and the accompanying drawings in which:

FIG. 1 is the schematic view of the structure of the inner pot of the existing roasting oven with steaming boxes;

FIG. 2 is the schematic view of the structure with the steaming boxes put in the inner pot through the pallet;

FIG. 3 is the schematic view of the structure of an electric roasting oven assembled from the inner pot shown in FIG. 2;

FIG. 4 is the schematic view of the structure of the first embodiment of the utility model;

FIG. 5 is the view seen from direction A of FIG. 4;

FIG. 6 is the schematic view of the pallet of FIG. 5 in a semi-foldable state;

FIG. 7 is the schematic view of the structure of a second embodiment of the utility model;

FIG. 8 is the schematic view of the structure of a third embodiment of the utility model;

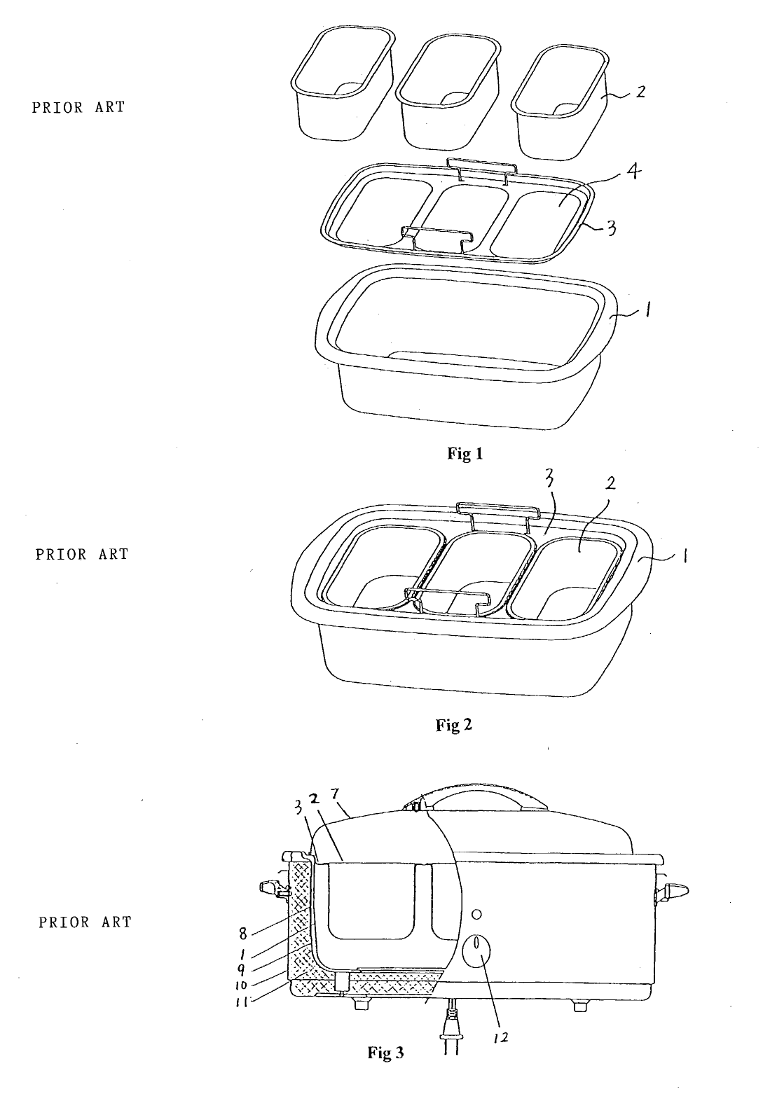

### THE PREFERRED EMBODIMENT

A preferred embodiment comprises an inner pot (1) of the electric roasting oven. The roasting oven comprises an inner pot (1), steaming boxes (2) with lid rims (6), a pallet (3) with openings (4), a hinge (5), a cover (7), an electro-thermal element (8), an outer pot (9), a housing (10), heat preservation material (11), and a panel (12).

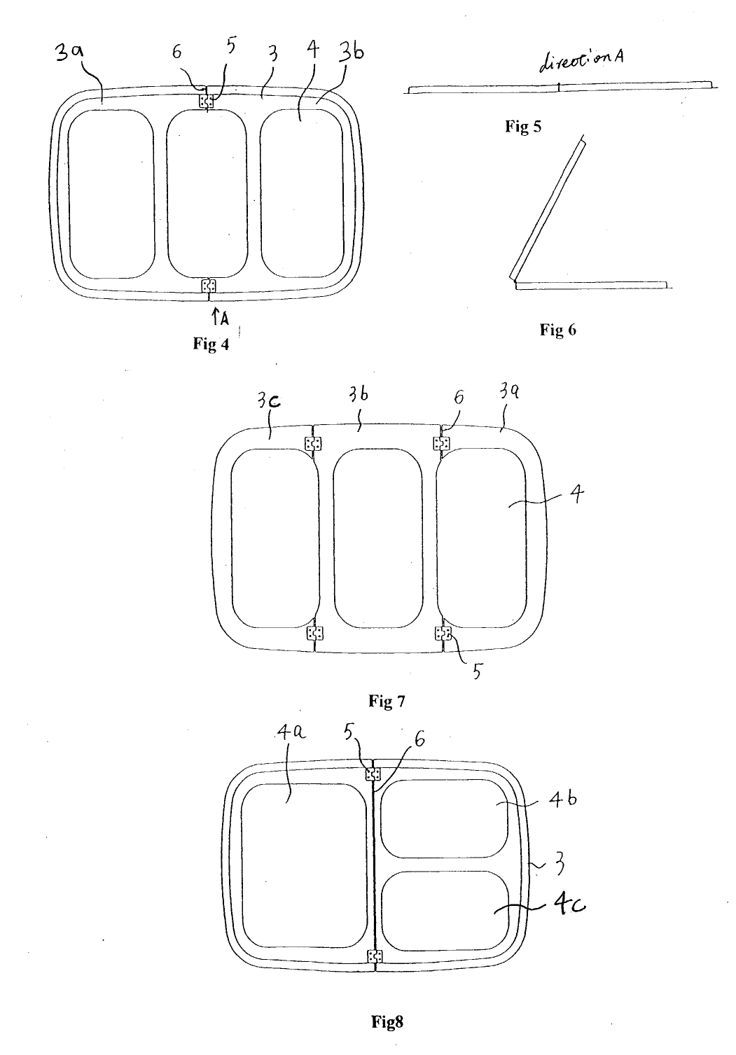

FIGS. 4, 5 and 6 disclose a first embodiment of the present invention. The length of the pallet (3) of this preferred embodiment, is greater than the width on which three openings (4) arranged lengthwise are provided. The pallet (3) is divided into two sections (a first (3a) and a second section (3b)) down its middle part and the divided surfaces are connected by hinges (5). The division line (6) is located on the pallet (3) between the lengthwise edge of the opening (4) and the lengthwise side edge of the pallet (3). Also, a positioning retainer having a maximum angle of rotation of 180° is provided on the hinge (5). Thus, the pallet (3) can be folded in half (see FIG. 6).

Embodiment 2 is shown in FIG. 7. The length of the pallet (3) of this preferred embodiment is greater than the width. Three openings (4) arranged lengthwise are provided. The pallet (3) is divided into three sections (a first (3a), a second (3b) and a third section (3c)) down its length and the divided surfaces are connected by hinges (5). Two division lines (6) are located on the pallet (3) between the lengthwise edge of the opening (4) and the lengthwise side edge of the pallet (3). The pallet (3) can be folded into three sections.

Embodiment 3 is shown in FIG. 8. The length of the pallet (3) of this preferred embodiment is greater than the width. There are three openings (4). The first two openings (4b, c) are arranged side by side in the width direction. The length of the third opening (4a) is greater than its width. In addition, the third opening (4a) is arranged lengthwise with respect to the first two openings (4b). The shape of the three openings (4) resembles a protrusion on the top of a base bar which is divided into two parts. That is, it looks like a Chinese character having three boxes arranged such that two boxes are placed side by side on the bottom and a third box is centered on top of the two bottom boxes. The pallet (3) is divided down the middle into two sections and the divided surfaces are connected by the hinges (5). The division line (6) is located on the pallet (3) between first two openings (4b,c) are arranged side by side and the third opening (4a). The pallet (3) can be folded in half.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A pallet for holding steaming boxes in the inner pot of a roasting oven, comprising:
a pallet comprising a plurality of sections and at least one opening, whereby steaming boxes are placed in said at least one opening, and
at least one hinge operably connected between said plurality of sections, whereby said pallet is foldable.

2. The pallet for the steaming boxes in the inner pot of the roasting oven according to claim 1, wherein said pallet further comprises:
wherein said plurality of sections comprises a first section and a second section;
wherein said at least one opening comprises a first, a second and a third opening arranged lengthwise across said pallet;
whereby said first and said second section are operably connected by said hinge located between a lengthwise edge of one of said openings and a lengthwise side edge of said pallet; and
wherein a length of said pallet is greater than a width of said pallet.

3. The pallet for the steaming boxes in the inner pot of the roasting oven according to claim 1, wherein said pallet further comprises:
wherein said plurality of sections comprises a first section, a second section and a third section;
wherein said at least one opening comprises a first, a second and a third opening arranged lengthwise across said pallet;
wherein said at least one hinge comprises a first hinge, whereby said first and said second section are operably connected by said hinge located between a lengthwise edge of one of said openings and a lengthwise side edge of said pallet, and a second hinge, whereby said second and said third section are operably connected by a second hinge located between a lengthwise edge of another of said openings and said lengthwise side edge of said pallet; and
wherein a length of said pallet is greater than a width of said pallet.

4. The pallet for the steaming boxes in the inner pot of the roasting oven according to claim 1, wherein said pallet further comprises:
wherein said plurality of sections comprises a first section and a second section arranged lengthwise side by side;
wherein said at least one opening comprises a first, a second and a third opening, wherein said first section comprises said first and said second opening arranged side by side in a width direction and said second section comprises said third opening centered widthwise with respect to said first and said second openings;
whereby said first and said second section are operably connected by said hinge; and
wherein a length of said pallet is greater than a width of said pallet.
